(19) United States
(12) Patent Application Publication
(10) Pub. No.: US 2010/0064397 A1
(43) Pub. Date: Mar. 11, 2010

(54) CONTROLLED ATOMIC FORCE MICROSCOPE

(75) Inventors: Michal Hrouzek, Grenoble (FR); Alina Anca Voda, Grenoble (FR); Joel Chevrier, Saint Egreve (FR); Gildas Besancon, Grenoble (FR); Fabio Comin, Veurey Voroize (FR)

Correspondence Address: Howard IP Law Group, P.O. Box 226, Fort Washington, PA, 19034, US

(73) Assignees: UNIVERSITE JOSEPH FOURIER, Grenoble Cedex 9 (FR); EUROPEAN SYNCHROTRON RADIATION FACILITY, Grenoble Cedex (FR); INSTITUT NATIONAL POLYTECHNIQUE DE GRENOBLE, Grenoble Cedex 1 (FR); CENTRE NATIONAL DE LA RECHERCHE SCIENTIFIQUE, Paris Cedex 16 (FR)

(21) Appl. No.: 12/302,160

(22) PCT Filed: May 23, 2007
(86) PCT No.: PCT/FR2007/051319

§ 371 Date: Mar. 18, 2009

(30) Foreign Application Priority Data
May 24, 2006 (FR) 06/04674

(51) Int. Cl. G01Q 60/24

(52) U.S. Cl. 850/33

(57) ABSTRACT

The invention relates to an atomic force microscope including a microtip placed on a flexible support connected to a microscope head facing a surface to be studied, which includes means for controlling the distance between the head and the surface for a given value and means for inhibiting vibration of the microtip.

### FIELD OF THE INVENTION

The present invention relates to the measurement of surface variations with an atomic force microscope.

### DISCUSSION OF PRIOR ART

FIG. 1 very schematically shows the detection end of an atomic force microscope. This detection end is formed of a tip 1 arranged at one end of a cantilever 2 having its other end built-in at the level of a support 3. The cantilever for example has a length from 50 to 500 μm, a width from 20 to 60 μm, and a thickness from 1 to 5 μm. When the tip is arranged close enough to a surface of a sample 5 to be studied, an atomic interaction force appears between the end of tip 1 and the surface of sample 5. Thus, when the tip is shifted with respect to sample 5 in the direction of axis x of FIG. 1, or conversely, the cantilever is subject to motions in the direction of axis z which translate the surface unevennesses of sample 5. To measure the position of the cantilever, various means have been provided. The most current one is an optical sensor of a beam reflecting on the cantilever. The sensor may comprise interferometric means. Such microscopes, which have been known for some twenty years, are for example used to measure surface unevennesses having dimensions on the order of one nanometer, that is, molecules, or even atoms, can be observed.

Two main ways of using an atomic force microscope have been provided.

In a first case, an extremely flexible cantilever (of very low stiffness) is used. The tip is put in permanent contact with the measured surface and the cantilever deflection is recorded. In this case, there is a strong repulsive interaction with the surface to be measured, which results in risks of damage of the tip and/or of the measured surface.

In a second case, the cantilever is driven to oscillate in the vicinity of its resonance frequency. Close to the scanned surface, the attractive and repulsive interaction forces modulate this phase and/or frequency oscillation. The analysis of the modulation of the cantilever oscillation enables determining said interaction. In this case, the sensitivity of the measurement is basically limited by the thermal noise of the cantilever. There exist various alternatives according to whether the tip is allowed or not to hit the studied surface for short time periods or according to the obtained regulation mode: regulated oscillation amplitude and constant excitation frequency or permanent search for the resonance frequency given the frequency shift induced by the interaction. Whatever the implementation detail, this permanent oscillation mode of the cantilever raises problems, inherent to its concept, when distances and interaction forces are desired to be measured in a liquid medium, for example, a biological medium. Indeed, this technique is based on the forced oscillation of the cantilever and fundamental problems are posed to use such an atomic microscope in a liquid medium: how to combine the oscillation and the liquid medium, how to conciliate the marked resonance necessary to have a good resolution and the damping due to the fluid.

### SUMMARY OF THE INVENTION

Thus, an object of the present invention is to provide an atomic microscope structure adapted to a new operating mode which overcomes some at least of the disadvantages of the previously-discussed use modes and which is further perfectly adapted to a use in a liquid medium.

To achieve all or part of these objects, the present invention provides an atomic force microscope comprising a microtip arranged on a flexible support linked to a microscope head in front of a surface to be studied, comprising means for controlling to a given value the distance between said head and said surface, this distance being measured directly below the tip, and means controlled to inhibit the microtip oscillation.

According to an embodiment of the present invention, the microtip is arranged at the end of a built-in cantilever.

According to an embodiment of the present invention, the means for inhibiting the microtip oscillation comprise conductive means integral with the microscope head, in capacitive coupling with the cantilever and receiving, with no high-frequency filtering, the control signal used to stabilize the distance between the microscope head and the surface to be studied.

According to an embodiment of the present invention, said conductive means receive frequencies ranging up to beyond the frequency of the third resonance mode of the cantilever.

According to an embodiment of the present invention, the transverse scan speed between the microscope head and the surface to be studied is selected so that the surface variation measurement only has frequency components at frequencies smaller than the natural cantilever oscillation frequency.

### BRIEF DESCRIPTION OF THE DRAWINGS

The foregoing and other objects, features, and advantages of the present invention will be discussed in detail in the following non-limiting description of specific examples in connection with the accompanying drawings, among which:

FIG. 1 very schematically shows the active portion of an atomic microscope;

FIG. 2 very schematically shows a first embodiment of an atomic microscope according to the present invention;

FIG. 3 is a block-diagram representation of the present invention;

FIGS. 4A to 4D are curves illustrating a first example of the use of an atomic microscope according to the present invention; and

FIGS. 5A to 5D are curves illustrating a second example of the use of an atomic microscope according to the present invention.

### DETAILED DESCRIPTION

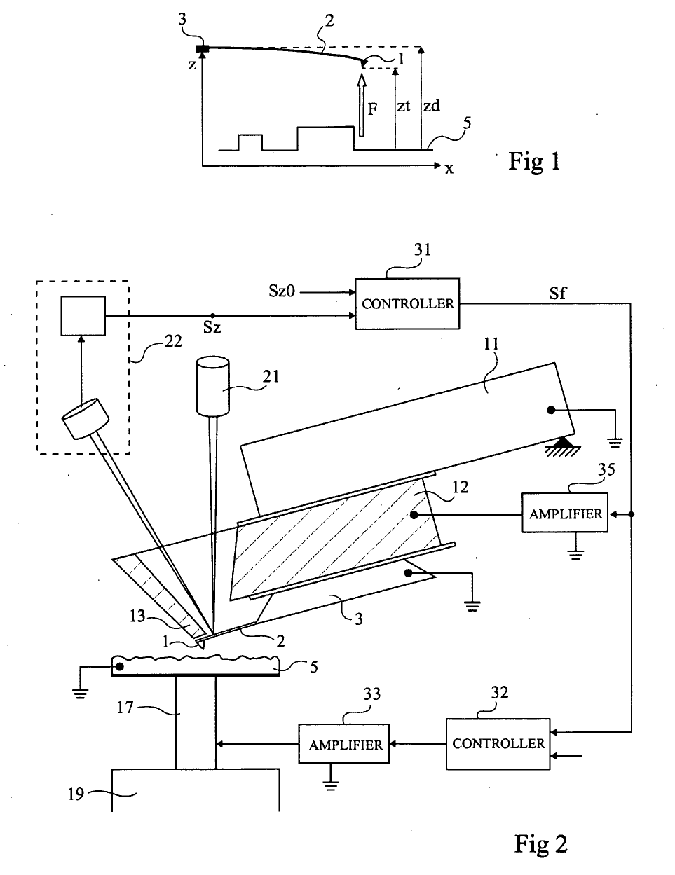

FIG. 2 illustrates an embodiment of an atomic microscope according to the present invention. Tip 1 is arranged at the end of a cantilever of a conductive material 2, for example, heavily-doped silicon, etched from a silicon support 3. The support is integral with a steerable atomic microscope head, settable in position 11. In the drawing, an intermediary part 12 of a conductive material, having one end 13 capacitively coupled with the free end of cantilever 2, has been shown. Intermediary part 12 is electrically isolated from support 3 and, preferably, also from head 11. The support and the head are for example both grounded. Sample 5 to be measured is laid via a piezoelectric structure 17 on an X-Y table 19 for example enabling to ensure the displacement in direction x mentioned in relation with FIG. 1. Intermediary part 12 comprises an opening allowing cantilever 2 to be illuminated by a laser 21 having its reflected beam detected by a photodetector 22 arranged in known fashion to provide a signal corresponding to the position, z, of the cantilever.

The present invention provides maintaining distance zd between the cantilever support (the assembly formed of support 3, of intermediary part 12, and of microscope head 11) and sample 5 constant. The present invention further provides stabilizing the cantilever, that is, avoiding its oscillations, so that distance zt between the measurement tip and the surface of sample 5 is effectively constant (thus, distance zd is a distance taken directly below the tip).

Indeed, as acknowledged by the inventors, normally, in the absence of any action on the cantilever, said cantilever tends to oscillate under the effect of the thermal noise at frequencies close to its natural frequency and to its harmonics. For a silicon cantilever having a length L from 50 to 500 μm, a width from 10 to 60 μm, and a thickness e from 1 to 5 μm, the natural frequency of the cantilever will range between 10 and 500 kHz. For example, for a cantilever having a length L of 125 μm, a thickness e of 4 μm, and a stiffness of 40 N/m, the natural frequency will be 300 kHz.

According to an embodiment of the invention, the cantilever position signal, Sz, provided by measurement device 22 is compared with a desired value Sz0, preferably 0, in a stabilization controller 31. The output signal of the controller is provided to a controller 32 of the set point of piezoelectric structure 17 supporting sample 5. The signal of controller 32 is amplified by an amplifier 33. This setting signal comprises frequency components substantially ranging from D.C. to a frequency which depends on the speed at which the sample is scanned under the microscope and which, as will be seen hereafter, may be on the same order of magnitude as the natural cantilever oscillation frequency but is preferably much smaller.

The output signal of stabilization controller 31 is also provided to an amplifier 35 providing a voltage to intermediary part 12 or at least to its end 13 which acts by capacitive effect on cantilever 2. Amplifier 35 amplifies the frequencies ranging from a value lower than that of the fundamental cantilever resonance frequency to values as high as possible, to correct the resonance frequencies of higher orders. Preferably, a frequency range enabling to compensate for the cantilever oscillation up to high frequencies, typically at least up to the frequency of the third cantilever resonance mode, will be selected.

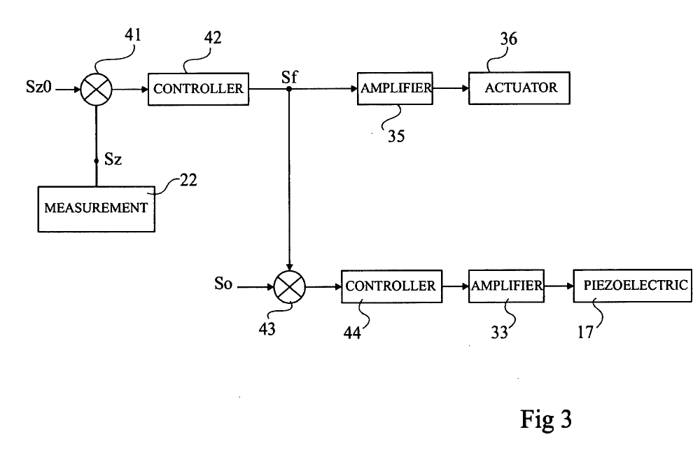

This control chain is shown in the form of block-diagrams in FIG. 3. Photodetector 22 providing a signal Sz having its output compared with a desired position signal Sz0 in a comparator 41, followed by a stabilization controller 42, are shown, elements 41 and 42 altogether corresponding to controller 31 of FIG. 2. Output control signal Sf of this controller is provided, on the one hand, to a second comparator 43 followed by a controller 44, with comparator 43 and controller 44 altogether corresponding to controller 32 of FIG. 2. Comparator 43 compares control signal Sf with a desired signal S0. Controller 44 provides a positioning voltage which is sent via an amplifier 33 to piezoelectric assembly 17 which outputs a signal corresponding to the sample position. Similarly, signal Sf is provided to an amplifier 35 and to a capacitive actuator 36 corresponding to the coupling between intermediary part 12 and cantilever 2. At any time, the integral of control signal Sf forms the interaction measurement signal according to the present invention.

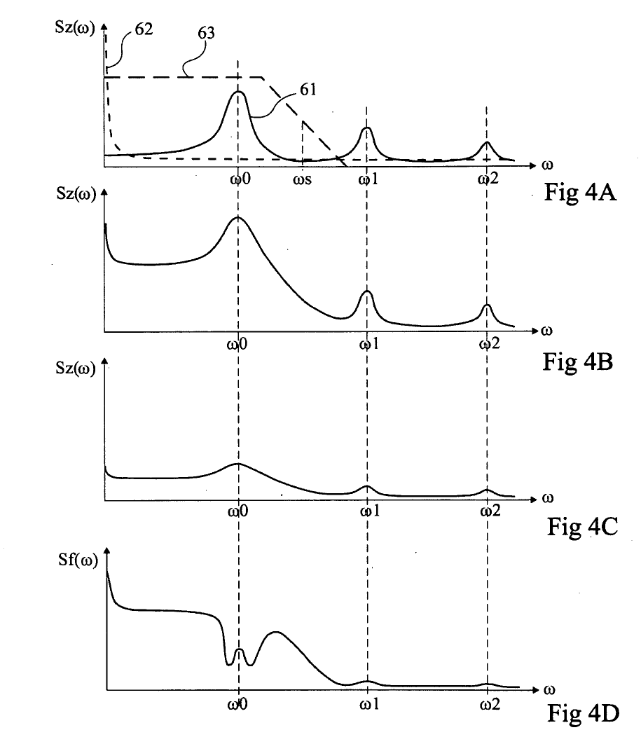

FIGS. 4A to 4C show signal Sz(ω) such as it would be under various assumptions. FIG. 4D shows the corresponding signal Sf(ω).

In FIG. 4A, what signal Sz(ω) would be at the input of controller 31 in the absence of any control has been shown. This signal would have three components 61, 62, and 63. Signal 61 is linked to the thermal noise of the system and comprises peaks at resonance frequency ω₀ of the cantilever and at higher resonance modes, ω₁, ω₂ . . . . Signal 62, of low frequency, is linked to the electrical and mechanical noise of the system. The signal due to the surface interaction between the tip and the sample moving in front of it is contained in the shown spectral band 63. This surface interaction signal may comprise frequencies up to a value ωₛ linked to the speed at which the sample is being scanned.

FIG. 4B shows the resultant of the three components of FIG. 4A.

FIG. 4C shows the cantilever motion resulting from the damping according to the present invention. It has been assumed that this motion is not completely damped and a still relatively significant displacement has been show to have the invention better understood. It should however be noted that in practice, an attenuation of the motion by a factor on the order of 100 with respect to what the non-damped motion such as shown in FIG. 4B would be will be imposed.

FIG. 4D shows signal Sf(ω) measured at the output of controller 42 of FIG. 3, which corresponds to the provided control force. Of course, the value of this signal, as well as the damping efficiency, will depend on the selected cut-off frequencies and on the amplification rates of the various amplifiers.

It should be noted that the variation of the control force necessary to the cantilever damping according to frequency depends on the shape of the cantilever response function. For an equal displacement amplitude, a much larger force is necessary to damp a displacement outside of a resonance range than to damp a displacement within a resonance frequency range (this accounts for the trough in the control force for a constant displacement near the resonance).

In other words, the displacement induced by a signal of given amplitude at a frequency located outside of a resonance range would be practically unnoticeable with respect to the displacement induced by this same signal at a frequency located in a resonance range. However, the forces necessary to cancel the displacements will be substantially equal. Thus, the influence of a uniform thermal noise, which is the majority influence at resonance frequencies in the representation of the displacement of FIG. 4C, fades at such resonance frequencies on the damping force curve of FIG. 4D. The integral of the damping power curve of FIG. 4D will thus show the influence of an interaction outside of resonance frequency ranges much better than the integral of the displacement curve of FIG. 4B, in which the influence of the noise component at resonance frequencies would be far from negligible.

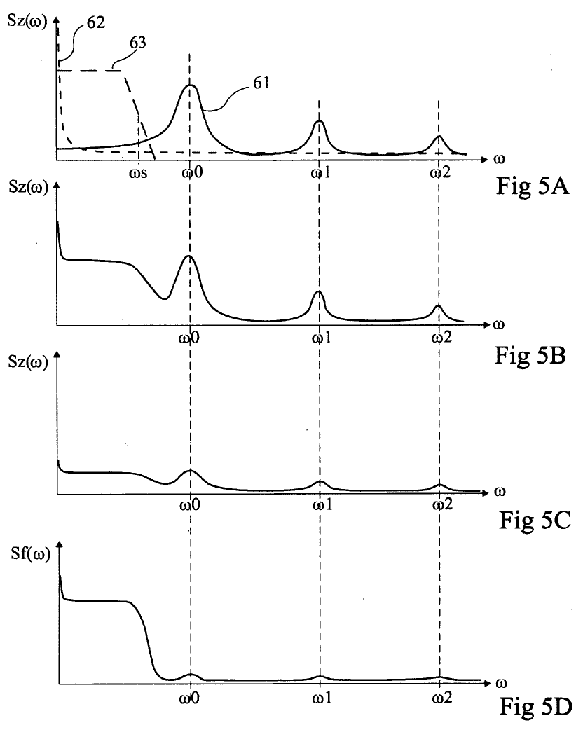

To further improve the results of the present invention, the conditions illustrated in FIGS. 5A to 5D, which respectively correspond to FIGS. 4A to 4D, may be adopted. The difference between these drawings results from the selection of the relative scan speed between the microtip and the sample, whereby the interaction signal is not likely to contain components at the cantilever resonance frequency.

As illustrated in FIG. 5A, the scan speed between the microtip and the sample is selected so that the highest frequency component likely to result from the surface interaction is smaller than the natural cantilever frequency. It should be noted that the damping stress which appears in FIG. 5D essentially comprises a component linked to the surface interaction. A more specific measurement of the interaction will thus be obtained.

According to cases, a fast scanning such as illustrated in relation with FIGS. 4A to 4D may be selected, however providing a good measurement of the sample surface variations, or a slower scanning such as illustrated in relation with FIGS. 5A to 5D may be selected if a homogeneous processing of all the frequency components of the signal is desired to be obtained. For example, if living matter surfaces are desired to be observed in motion, a relatively fast scanning, corresponding to the conditions of FIG. 4, will be selected.

According to a first advantage of the present invention, the absence of cantilever oscillation results in that the measurement of the interaction force is performed for an accurate distance and not for a distance average as in the case where the cantilever is permanently driven to oscillate. This intrinsically improves the measurement accuracy.

According to a second advantage of the present invention, the absence of oscillation of the cantilever makes the invention well adapted to a measurement in a liquid medium. Indeed, in such a medium, the oscillations would be disturbed by the ambient medium and the creation of oscillations in the medium may result in various disadvantages.

According to a third advantage of the present invention, the cancelling by the control loop of cantilever oscillations causes a decrease in the thermal noise and thus a large increase in the measurement accuracy. Indeed, in a conventional system, the thermal noise essentially translates as an excitation of the cantilever which starts resonating. Thus, the damping of the oscillations is equivalent to a cooling of the entire system, which would be impossible in a liquid medium.

According to a fourth advantage of the present invention, it enables to perform faster scannings than prior devices.

Of course, the present invention is likely to have many variations which will occur to those skilled in the art, especially as concerns the forming of the various described electric and electronic circuits. Further, the present invention applies to various type of atomic force microscopes, for example, microscopes in which the microtip, instead of being supported by a cantilever, is supported by another flexible structure, for example, a membrane.

1. An atomic force microscope comprising a microtip arranged on a flexible support linked to a microscope head in front of a surface to be studied, comprising:
means for controlling to a given value the distance between said head and said surface, this distance being measured directly below the tip, and
means controlled to inhibit the microtip oscillation.

2. The atomic microscope of claim 1, wherein, at any time, a signal for measuring the interaction with the surface to be studied is formed of the integral of a control signal (Sf(ω)).

3. The atomic microscope of claim 1, wherein the microtip is arranged at the end of a built-in cantilever.

4. The atomic microscope of claim 3, wherein the means for inhibiting the microtip oscillation comprise conductive means integral with the microscope head, in capacitive coupling with the cantilever and receiving, with no high-frequency filtering, a control signal used to stabilize the distance between the microscope head and the surface to be studied.

5. The microscope of claim 4, wherein said conductive means receive frequencies ranging up to beyond the frequency of the third resonance mode of the cantilever.

6. The microscope of claim 2, wherein the transverse scan speed between the microscope head and the surface to be studied is selected so that the surface variation measurement only has frequency components at frequencies smaller than the natural cantilever oscillation frequency.
